(19) United States
(12) Patent Application Publication
(10) Pub. No.: US 2022/0187539 A1
(43) Pub. Date: Jun. 16, 2022

(54) RIBBON SPLICING TOOLS AND METHODS

(71) Applicant: CORNING RESEARCH & DEVELOPMENT CORPORATION, Corning, NY (US)

(72) Inventors: Jason Daniel Andrews, Coon Rapids, MN (US); Vincent Albert Boggia, Woodstock, GA (US); Richard Shane Brittain, Vale, NC (US); Keith Harold Lail, Connelly Springs, NC (US); Kenneth Darrell Temple, JR., Newton, NC (US); Benjamin Gray Whitener, Newton, NC (US)

(21) Appl. No.: 17/684,581

(22) Filed: Mar. 2, 2022

Related U.S. Application Data
(63) Continuation of application No. PCT/US2020/050819, filed on Sep. 15, 2020.
(60) Provisional application No. 62/902,132, filed on Sep. 18, 2019.

(51) Int. Cl. G02B 6/255

(52) U.S. Cl. CPC G02B 6/2555

(57) ABSTRACT

A ribbon handler assembly holds an optical fiber ribbon during thermal stripping, cleaving and mass fusion splicing. The handler assembly includes a body defining a ribbon channel in an upper surface, an array section of fiber grooves extending longitudinally a predefined length from one end of the ribbon channel, wherein a nominal spacing of each individual groove of the array section of fiber grooves is greater than a nominal fiber spacing of fibers in an optical fiber ribbon configured to be placed into the ribbon channel.

### CROSS-REFERENCED TO RELATED APPLICATIONS

This application is a continuation of International Application No. PCT/US2020/050819 filed on Sep. 15, 2020, which claims priority to U.S. Provisional Application Ser. No. 62/902,132 filed on Sep. 18, 2019, the content of each of which is relied upon and incorporated herein by reference in their entirety.

### BACKGROUND

The disclosure relates generally to optical communication cables and more particularly to tools and methods for mass fusion splicing of the optical fibers in those cables. Demand is growing for higher fiber count cables and/or higher density of optical fibers in a single cable. As cable prices have decreased over the years, cable installation costs have continued to increase. Accordingly, there is a desire to put more fibers in the same space in order to reduce total installed costs. The trend is toward smaller diameter cables and/or the most fibers possible that can fit inside a given diameter duct space. One option for cable manufacturers to meet this demand is with ribbon cables having densely stacked ribbons of optical fibers or solutions that rely on rollable ribbon concepts, which incorporate, for example, intermittent webs lightly tacking the fibers together to create flexible ribbons that can be more easily rolled to conform to high density packing in a cable jacket or duct. Moreover, new optical fiber designs, in particular those having smaller outside diameters, such as 200 μm optical fibers, are available for use in these ribbon cables. Replacing the larger 250 μm fibers that have been used in conventional ribbon cables can allow even denser fiber counts in cables having the same or smaller size parameters as those conventional ribbon cables.

A key customer value for these cables remains the desire that the fibers can still be mass fusion spliced. Moreover, the ability to mass fusion splice twelve 200 μm to twelve 250 μm fibers is required to enable successful integration of these new cables into existing network infrastructures. However, when trying to mass fusion splice, for example twelve 200 μm fibers in ribbon form to twelve 250 μm fibers in ribbon form, each one of the fibers in the 200 μm ribbon needs to be offset some distance to have its core line up with the core of the corresponding fiber in the 250 μm ribbon.

Typical mass fusion splice machines have two sets of V-grooves designed to accurately align each fiber of a twelve-fiber 250 μm ribbon to each corresponding fiber of a second twelve-fiber 250 μm ribbon for splicing. In addition, these mass fusion splice machines use fiber handler assemblies during preparation of the fibers for splicing outside of the machine, placing and aligning the fibers into the v-grooves of the machines. The handler assemblies are used to hold the ribbon while removing a distal section of the ribbon matrix to expose the individual fibers for splicing. In addition, the handler assemblies separate the fibers into the correct spacing to align with the v-grooves in the splicing machines. The handler assembly for each ribbon to be spliced is typically mounted in a splicing machine to rest at a slight downward angle to bend the fibers slightly as they enter the V-groove arrays, using the bending stiffness of the individual fibers to lay them firmly in the V-grooves prior to closing a retaining lid of the splicing machine.

There is a need to have specialized handler assemblies and methods of splicing that enable use of conventional splice machines for splicing of a first optical fiber ribbon having a first nominal spacing (e.g., 200 μm) to a second optical fiber ribbon having a second nominal spacing (e.g., 250 μm) different from the first nominal spacing.

### SUMMARY

Conventional ribbon cables typically comprise stacks of 12 fiber ribbons of 250 μm fibers. In accordance with the desire to achieve higher fiber densities in cables without enlarging the space required to house the higher fiber counts, aspects of the present disclosure are based on 200 μm low loss optical fibers used in ribbons or ribbon stacks and the need to splice those ribbons to other 200 μm fiber ribbons or 250 μm fiber ribbons using existing splicing machines that are set up to splice 250 μm fiber ribbons to 250 μm fiber ribbons.

FIG. 1 illustrates the offset issue when splicing 200 μm fiber ribbons (which may actually have a 208 μm outside diameter when including a coloring layer) to 250 μm fiber ribbons. As shown in FIG. 1, fiber 1 of the 200 μm ribbon (shown on top) has to move out about 220 microns to get into the mass fusion splicer's 250 μm v-groove and meet the 250 μm fiber for splicing.

FIGS. 2A and 2B illustrate optional solutions for achieving the necessary offsets. Handler assemblies may have one or more center bar(s) that separate the 12 fibers into two sets of 6 fibers as shown in FIG. 2A using one center bar or three sets of 4 fibers as shown in FIG. 2B using two separating bars. At only 100 μm and 60 μm of offset respectively, the methods shown in FIGS. 2A and 2B feasibly place the 200 μm fibers in the proper 250 μm V-grooves for mass fusion. However, a conventional solid matrix 200 μm ribbon must be split first, before using these methods. This takes extra effort and time before splicing, can lead to stray fibers after the split is performed, and needs geometry optimization (a special handler assembly) for the thicker ribbon with solid matrix.

Aspects of the present disclosure provide a novel handler assembly for use in conventional splicing machines that moves the fibers having a first nominal spacing to a different geometry to allow them to align with an opposing ribbon having a second nominal spacing. In accordance with certain aspects, the disclosure illustrates a handler assembly for moving the nominal spacing of the fibers of a 200 μm ribbon to align with the nominal spacing of the fibers in a 250 μm ribbon and methods of using the handler assembly with a conventional 250 μm splicer machine. Thus, typical installers can avoid the expense of specialty splicing machines by by swapping out a very small piece (the handler assembly) that is already considered interchangeable.

A method of splicing a first optical fiber ribbon having a first nominal spacing to a second optical fiber ribbon having a second nominal spacing different from the first nominal spacing includes thermally stripping an end portion of the first optical fiber ribbon to expose a first set of optical fibers and thermally stripping an end portion of the second optical fiber ribbon to expose a second set of optical fibers. The first set of optical fibers may then be placed into the first body of a first ribbon handler assembly and the second set of optical fibers placed into the second body of a second ribbon handler assembly. The first body of the first ribbon handler assembly comprises a first array of grooves defined in an upper surface of the first body for receiving the first set of optical fibers and the second body of the second ribbon handler assembly comprises a second array of grooves defined in an upper surface of the second body for receiving the second set of optical fibers. The first set of optical fibers has a nominal fiber size that is smaller than a nominal fiber size of the second set of optical fibers. Accordingly, the first array of grooves are tapered or flared to enlarge a nominal spacing of the first set of optical fibers to match a nominal spacing of the second set of optical fibers such that each exposed fiber of the first set of optical fibers aligns with a corresponding exposed fiber of the second set of optical fibers. Once the exposed fibers of the first set and the second set of fibers are secured in the respective ribbon handler assemblies, the ribbon handler assemblies may be individually placed into a splice machine for completion of the fusion splicing process.

### BRIEF DESCRIPTION OF THE DRAWINGS

FIG. 1 is a cross sectional view comparison of a conventional 250 μm 12 fiber ribbon to a 200 μm 12 fiber ribbon as aligned for splicing, in accordance with aspects of the present disclosure.

FIGS. 2A and 2B are cross-sectional views and associated parameter charts for dimensions of fiber separation of a 200 μm 12 fiber ribbon using handler assemblies having one or two center bars for separation, in accordance with aspects of the present disclosure.

FIG. 3A is an illustration of splice handler assembly, in accordance with aspects of the present invention.

FIG. 3B is an illustration the splice handler assembly of FIG. 3A in a position of use, in accordance with aspects of the present disclosure.

FIG. 4 is an enlarged view of aspects of the splice handler assembly shown in FIGS. 3A and 3B, in accordance with aspects of the present disclosure.

FIG. 5 is an illustration of another splice handler assembly, in accordance with aspects of the present disclosure.

### DETAILED DESCRIPTION

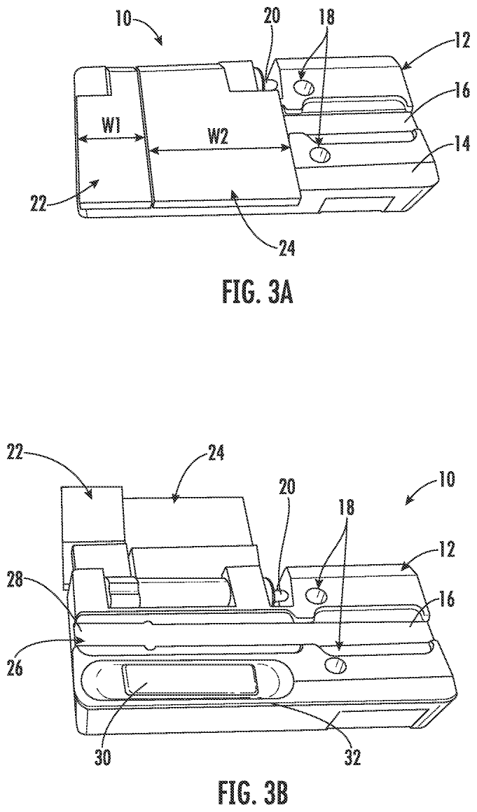

Referring to FIGS. 3A and 3B, a ribbon fiber handler assembly, shown as handler assembly 10, is shown according to aspects of the present disclosure. The handler assembly 10 includes a body 12, having an upper surface 14 that defines a fiber ribbon channel 16 or region that extends a longitudinal length of the body 12 and within which an optical fiber ribbon intended for splicing may be placed. The body 12 may be generally rectangular in shape and have one or more pin holes 18 for seating the handler assembly 10 into a splice machine (not shown).

Although generally described herein for splicing of twelve fiber ribbons, both standard and rollable ribbons, the handler assembly 10 may be dimensioned to accommodate other ribbon sizes as well (e.g., 4, 6, 8, 12, 16, 24, 32 fiber ribbons). The body 12 may be comprised of a polymer material that is injection molded or machined to have the properties and dimensions described herein. However, the body 12 may be comprised of any suitable material.

The body 12 of the handler assembly 10 may be machined to seat a hinge pin 20 for rotatably mounting a first door 22 and a second door 24. As shown in FIG. 3B and enlarged in FIG. 4, the ribbon channel 16 defines an array section of fiber grooves 26 at a distal end of the channel 16. The array of fiber grooves 26 may be formed such that each groove 28 of the array of fiber grooves 26 establishes a nominal spacing of the fibers that is larger than the nominal spacing of the fibers in the ribbon. For example, the handler assembly 10 may have an array of fiber grooves 26 with a nominal spacing of each groove formed to separate the fibers of a 200 μm ribbon to match what would be the nominal spacing of a 250 μm ribbon.

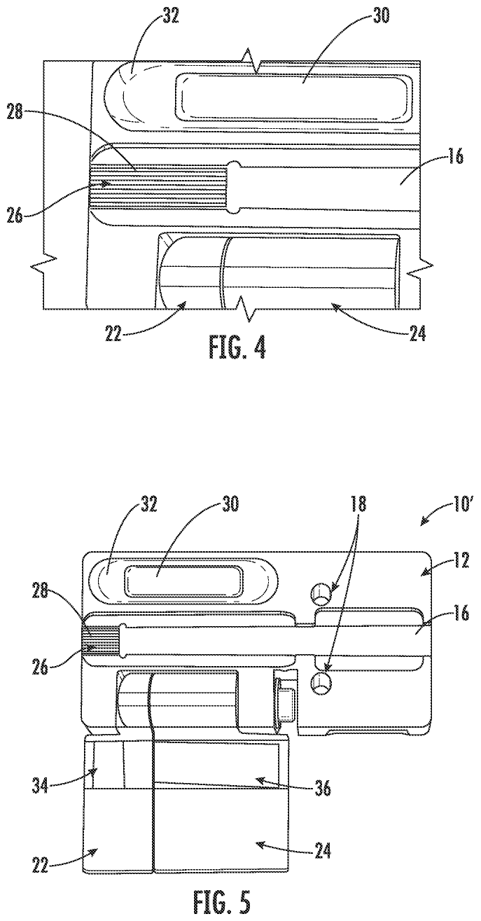

The array section of fiber grooves 26 may be formed to extend a predetermined length from one end of the body 12. The first door 22 may be sized to have a width W1 that substantially equals the longitudinal length of the array section of fiber grooves 26 formed in the ribbon channel 16. The second door 24 may have a width W2 that is wider than the width W1 of the first door 22 and is generally formed to abut or closely seat adjacent to the second door 24 when both doors are closed against the upper surface 14 of the body 12. The first door 22 and the second door 24 may be formed of a suitable metallic material such that each door is attracted to and couples with a magnet 30 that is seated in a magnet channel 32 formed in the upper surface 14 of the body 12. The magnet 30 sits substantially flush with the upper surface 14 of the body 12 such that when the first door 22 and/or the second door 24 is placed into a closed position (i.e., covering the ribbon channel 16), the free end of the respective door couples to and may be held closed by the magnet 30. As shown in FIG. 5, a first pad 34 and a second pad 36 made of rubber or any other suitable material may be coupled (e.g., adhesively applied) to the first door 22 and the second door 24, respectively. The first pad 34 and the second pad 36 may assist in a smoother closing of each door and are sized to enhance the tactile feel and function of each door as described in additional detail below.

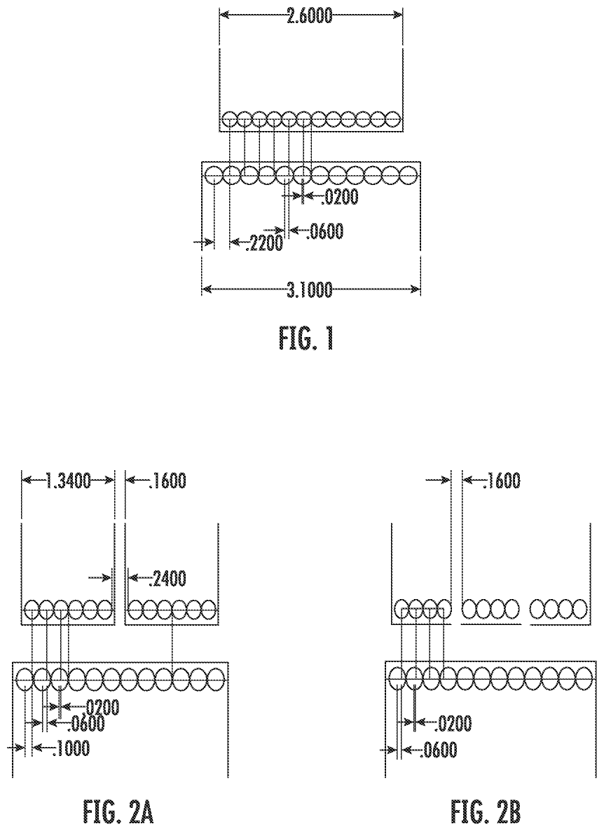

The handler assembly 10′ of FIG. 5 differs from the handler assembly 10 shown in FIGS. 1-4 primarily in the length of the array section 26. In accordance with aspects of the present disclosure, shortening the groove length of the array section 26 may facilitate a longer cleaved fiber length for the cleaving operation, making the overall operation described below easier in some cases.

In accordance with aspects of the present disclosure, a method of splicing a first optical fiber ribbon having a first nominal spacing different from a second nominal spacing of the V-grooves in a splicing machine includes thermally stripping an end portion of the first optical fiber ribbon to expose a first set of optical fibers. This may be done by, for example, placing a 200 μm ribbon into the handler assembly such that a portion of the ribbon extends out of the end of handler assembly 10 (same method when using handler assembly 10′) housing the first door 22 and the second door 24 for a full length of a thermal stripper bed. The first door 22 and the second door 24 are closed and the coatings are stripped from the ribbon using the thermal stripper. The exposed fibers may be cleaned using known cleaning procedures.

The handler assembly with the 200 μm ribbon may be removed from the thermal stripper. With the exposed fibers of the ribbon extending from the handler assembly 10 or 10′, the second door is opened. With a finger lightly pressed against or near the closed small door, the ribbon may be retracted (i.e., pulled longitudinally away from the first door 22) such that the exposed and stripped fibers are pulled into the handler assembly 10 under the first door 22. When the center of the outer fibers, e.g., fibers 1 and 12 in a twelve-fiber ribbon, reach the their respective grooves 18 as the fibers are being slid along the tapered groove array section 16 machined into the handler body 12, all of the individual fibers will fall into their respective grooves 18 and be seated. The fibers are thus flared out into the nominal spacing required to fit into the V-grooves designed for the spacing of a 250 μm ribbon. As the fibers fall down into their respective grooves during this seating action, the first door 22 is permitted to fully close, which creates an audible click when the first door 22 seats against the magnet 30. Moreover, with a finger lightly pressed on or resting near the first door 22, a tactile sensation is created by the closing action when the fibers become seated in the individual grooves 18. Furthermore, the sudden move of the fibers from a parallel position to flared position provides a visual cue that the fibers are seated. Thus, three sensual feedback mechanisms are engaged to note that the fibers are flared and ready for cleaving.

With fibers still extending from the handler assembly 10, the handler assembly may be placed into a cleaver and the fibers cleaved to length for the mass fusion splice. The handler assembly 10 with the cleaved fibers may now be placed into a splice machine with a 250 μm V-groove spacing and spliced normally. The cleaved ends of the flared 200 μm fibers will proceed into each of their respective 250 μm spaced V grooves as the handler is placed into the handler base within the splice machine. In addition to using the pin holes 18 to seat the handler assembly 10 into the splice machine, other grooves or detents, for example, may be machined into the handler assembly 10 as appropriate to ensure proper seating of the handler assembly 10 in a particular splice machine.

To achieve attenuation performance, aspects of the present disclosure may include cables with high performing 200 um fibers, such as fibers with improved microbend performance as disclosed in U.S. Patent Application Ser. No. 62/341,369, which is incorporated herein.

The present inventions have thus been described with reference to the exemplary embodiments, which embodiments are intended to be illustrative of inventive concepts rather than limiting. Persons of ordinary skill in the art will appreciate that variations and modifications of the foregoing embodiments may be made without departing from the scope of the appended claims.

What is claimed is:

1. A ribbon handler assembly for holding an optical fiber ribbon during thermal stripping, cleaving and mass fusion splicing, the handler device comprising:
a body defining a ribbon channel in an upper surface; and
an array section of fiber grooves extending longitudinally a predefined length from one end of the ribbon channel, wherein a nominal spacing of each individual groove of the array section of fiber grooves is greater than a nominal fiber spacing of optical fibers in the optical fiber ribbon configured to be placed into the ribbon channel.

2. The ribbon handler assembly of claim 1, further comprising a first door rotatably connected to the body, wherein the first door has a first width equal to or less than the predefined length of the array section of fiber grooves.

3. The ribbon handler assembly of claim 2, further comprising a second door rotatably connected to the body, wherein the second door has a second width that is wider than the first width and abuts or closely seats adjacent to the second door when both doors are closed against the upper surface of the body.

4. The ribbon handler assembly of claim 3, further comprising a magnet, wherein the first door and the second door are closed when abutting against directly against the magnet.

5. The ribbon handler assembly of claim 4, wherein the first door contacts the magnet with an audible click when each of the individual optical fibers of the optical fiber ribbon are seated properly in the respective individual groove of the array section of fiber grooves.

6. The ribbon handler assembly of claim 4, wherein a tactile sensation is created as the first door seats against the magnet when each of the individual optical fibers of the optical fiber ribbon are seated properly in the respective individual groove of the array section of fiber grooves.

7. The ribbon handler assembly of claim 4, wherein a visual cue is created as the first door seats against the magnet when each of the individual optical fibers of the optical fiber ribbon flare out to seat properly in the respective individual groove of the array section of fiber grooves.

8. The ribbon handler of claim 1, wherein a nominal spacing of each individual groove of the array section of fiber grooves is set to the nominal spacing required to fit the fibers into V-grooves designed for the spacing of a 250 μm ribbon.

9. The ribbon handler of claim 8, wherein the nominal fiber spacing of optical fibers in the optical fiber ribbon is equal to that for a 200 μm optical fiber ribbon.

10. A method of splicing a first optical fiber ribbon having a first nominal spacing using a splice machine with a V-groove having a second nominal spacing different from the first nominal spacing, the method comprising:
placing an optical fiber ribbon into a handler assembly such that the ribbon extends through a ribbon channel formed in an upper surface of the handler assembly and an end portion of the ribbon extends out of an end of handler assembly;
closing a first door and a second door of the handler assembly and placing the handler assembly into a thermal stripper and thermally stripping the end portion of the ribbon to expose a first set of fibers;
cleaning the exposed first set of fibers;
removing the handler assembly from the thermal stripper;
opening the second door only;
retracting the ribbon away from the first door such that the exposed and stripped first set of fibers are pulled into the handler assembly under the first door; and
ceasing retracting the ribbon upon engagement of one of a tactile, audible or visual indication that the first door closed completely.

11. The method of claim 10, further comprising:
placing the handler assembly into a cleaver and cleaving the fibers to length for the mass fusion splice.

12. The method of claim 10, further comprising:
placing the handler assembly into a splice machine such that the cleaved ends of the exposed first set of fibers will proceed into each of their respective V grooves in the splice machine.

13. The method of claim 10, wherein the audible indication occurs when the first door contacts a magnet with an audible click as each of the individual optical fibers of the optical fiber ribbon are seated properly in a respective individual groove of an array section of fiber grooves in the handler assembly.

14. The method of claim 10, wherein the tactile indication occurs when the first door seats against a magnet as each of the individual optical fibers of the optical fiber ribbon fall properly into a respective individual groove of an array section of fiber grooves in the handler assembly.

15. The method of claim 10, wherein the visual indication is created when each of the individual optical fibers of the optical fiber ribbon flare out to seat properly in a respective individual groove of an array section of fiber grooves.

16. The method of claim 12, wherein the handler assembly has pin holes that align with pins on the splice machine to properly seat the handler assembly in the splice machine.
